(19) United States
(12) Patent Application Publication
(10) Pub. No.: US 2026/0254722 A1
(43) Pub. Date: Aug. 27, 2026

(54) METHOD AND NETWORK NODE FOR TRANSFER OF A DIGITAL TWIN OF A NETWORK

(71) Applicant: Telefonaktiebolaget LM Ericsson (publ), Stockholm (SE)

(72) Inventors: Athanasios Karapantelakis, SOLNA (SE); Lackis Eleftheriadis, VALBO (SE); Konstantinos Vandikas, SOLNA (SE)

(21) Appl. No.: 18/994,375

(22) PCT Filed: Sep. 27, 2022
(86) PCT No.: PCT/SE2022/050855

§ 371 Date: Jan. 14, 2025

(30) Foreign Application Priority Data
Jul. 27, 2022 (GR) 20220100606

(51) Int. Cl. H04L 43/55; G06N 3/096; H04L 41/16

(52) U.S. Cl. CPC H04L 43/55; G06N 3/096; H04L 41/16

(57) ABSTRACT

A method to transfer a digital twin of a first network to a second network. The method comprises obtaining, for each router of the first network, a location of the router, mobility data of wireless devices attached to the router, and data traffic information of devices attached to the router. It further comprises computing a digital fingerprint of the first network on the basis of the router location, mobility data and data traffic information for all routers and comparing the digital fingerprint of the first network with a digital fingerprint of the second network, so that a transfer of the digital twin of the first network to the second network may take place on the basis of the comparison. Further, there are related methods, network nodes, computer programs, and computer program products.

### TECHNICAL FIELD

The present invention relates to a method and a network node for transfer of a digital twin of a network. A computer program product and a computer program are also disclosed.

### BACKGROUND

Digital twins are virtual representations of physical entities which simulate the behavior of their physical counterparts and can be used as a safe, cost-effective way for simulating various scenarios, e.g., to identify faults, test new software, and/or as a data source for training machine learning algorithms.

In particular, digital twins can be of use to network operators. One example is during network planning, where digital twins may for example be used to run simulation scenarios based on predicted network traffic and device mobility to choose the correct network configuration based on the customer requirements. Another example is using digital twins to generate data to train machine learning algorithms that automate some aspect of network automation operation (e.g., root cause analysis, predictive maintenance, etc.).

Digital twins are ideal for private networks due to the relatively small size of such network. On a public network, it may be difficult to design digital twins that can scale as there exist thousands of radio base stations and many different types of services with different requirements in different parts of the network.

In current state of the art, creation of a digital twin is tied to the physical object and the environment in which the object exists. As such, the idea of transfer of a digital twin to another physical object and/or environment is not well-explored, although there exist technical solutions for transferring certain parts of digital twins (e.g., transfer learning for neural networks).

In the context of private networks such as private Wi-Fi networks or private 5G networks, digital twin transfer may be highly beneficial, as it can help reduce cost in various stages of the network lifetime, for example, during network design and rollout, and also during operation and maintenance. In case of simple digital twins, e.g., those simulating closed loops within a product (e.g., the operation of a toaster, refrigerator, or TV), transfer of one digital twin of a first product to a second product is relatively easy; especially if the model/product is the same or similar. However, there can also be cases of more complex digital twins. The complexity here refers to two aspects:
The value distributions of data received from the data pipeline may differ between the first product and the second product meaning that any possible models within the environment model that are trained or set to some thresholds may not be correct.
The number and type of physical entities as well as the environmental parameters may differ between the first product and the second product.

Such complexities render the case that two networks will be exactly the same in terms of environment, location and characteristics of radio base stations, transport network, core network and characteristics of traffic to/from devices highly improbable. It is therefore of great interest to develop a method and apparatus to enable transfer of digital twins between networks.

In prior art, methods associated with digital twins focus on constructing database structures where digital twins may be stored and where digital twins may be exchanged.

These include U.S. Pat. No. 10,404,569 B2 which discloses an Internet of Things, IoT, associate configured to receive a digital twin from a data warehouse, the digital twin corresponding to a twinned physical system.

Alternatively, US2020133213 A1 discloses a building management system including one or more memory devices configured to receive timeseries data and, based on the received timeseries data, identify an object in a database.

### SUMMARY

It is an object of the present disclosure to provide a method and a network node facilitating transfer of a digital twin between networks.

According to a first aspect of the invention, there is a method to transfer a digital twin of a first network to a second network. The first network comprises N routers and the second network comprises M routers. The method comprises obtaining, for each of the N routers of the first network, a location of the router, mobility data of wireless devices attached to the router, and data traffic information of devices attached to the router. It further comprises computing a digital fingerprint of the first network on the basis of the router location, mobility data, and data traffic information for all N routers. Finally, it comprises comparing the digital fingerprint of the first network with a digital fingerprint of the second network, so that a transfer of the digital twin of the first network to the second network may take place on the basis of the comparison. Hereby is achieved that a digital twin of a first network may be assessed for transfer to a second network in an intelligent manner.

According to an embodiment of the first aspect, the method further comprises transferring the digital twin of the first network to the second network. Hereby is achieved that the digital twin of the first network may be exploited by the second network.

According to an embodiment of the first aspect, transferring the digital twin from the first network to the second network comprises using transfer learning to adapt the first digital twin to the second network. Hereby is achieved that the digital twin of the first network may be modified to be more useful to the second network.

According to an embodiment of the first aspect, transferring the digital twin of the first network to the second network comprises using domain adaptation to adapt the first digital twin to the second network.

According to an embodiment of the first aspect, transferring the digital twin of the first network to the second network comprises using deep neural network transfer learning to adapt the first digital twin to the second network.

According to an embodiment of the first aspect, computing the digital fingerprint of the first network comprises applying a lossless compression algorithm to the access point location data, the mobility data, and the data traffic information obtained from each router of the N routers. Hereby is achieved that the digital fingerprints may be stored and compared more efficiently.

According to an embodiment of the first aspect, the method further comprises creating a digital fingerprint of the second network and comparing each element of the digital fingerprint of the first network with each element of the digital fingerprint second network.

According to an embodiment of the first aspect, comparing the digital fingerprint of the first network with the digital fingerprint of the second network comprises calculating a similarity measure as a function of the digital fingerprint of the first network and the digital fingerprint of the second network. Hereby is achieved that a mathematical measure of the similarity between the fingerprints is obtained.

According to an embodiment of the first aspect, comparing the digital fingerprint of the first network to the digital fingerprint of the second network comprises comparing the similarity measure with a threshold. If the similarity is above the threshold, the method further comprises transferring the digital twin of the first network to the second network. Hereby is achieved that the decision to transfer the digital twin of the first network to the second network may be taken automatically.

According to an embodiment of the first aspect, comparing the digital fingerprint of the first network to the second network includes comprises comparing the similarity measure with a threshold. If the similarity is below the threshold, the method further comprises not transferring the digital twin of the first network to the second network.

According to an embodiment of the first aspect, the method further comprises storing the digital fingerprint of the first network or the digital fingerprint of the second network in a database. Hereby is achieved that digital fingerprints may be compared some time after being created.

According to an embodiment of the first aspect, the method further comprises storing the digital fingerprint of the first network or the digital fingerprint of the second network in a database taking the form of a distributed and immutable ledger.

According to an embodiment of the first aspect, the first network is a cellular network and the digital fingerprint further comprises network slice information associated to each router of the N routers.

According to an embodiment of the first aspect, the first network is a cellular network and the digital fingerprint further comprises quality of service information associated to each router of the N routers.

According to an embodiment of the first aspect, the first network is a cellular network and the digital fingerprint of the first network further comprises node energy measurements information associated to each router of the N routers.

According to a second aspect of the invention, there is a network node in a network comprising N routers. The network node comprises a memory and processing circuitry adapted to obtaining, for each of the N routers in the first network, a location of the router, mobility data of wireless devices attached to the router, and data traffic information of devices attached to the router. The network node is further adapted to compute a digital fingerprint of the first network on the basis of the router location, mobility data, and traffic information for all N routers. The network node is further adapted to compare the digital fingerprint of the first network with a digital fingerprint of a second network, so that transfer of a digital twin of the first network to the second network may take place on the basis of the comparison.

According to an embodiment of the second aspect of the invention, the network node is further adapted to storing the digital fingerprint of the first network in a database.

According to an embodiment of the second aspect of the invention, the database is in the form of a distributed ledger.

According to an embodiment of the second aspect of the invention, the calculation of the digital fingerprint comprises applying a lossless compression algorithm to the data from each router.

According to an embodiment of the second aspect of the invention, the first network is a Wi-Fi network.

According to an embodiment of the second aspect of the invention, the first network is a cellular network.

According to an embodiment of the second aspect, the first network is a heterogenous network.

According to an embodiment of the second aspect of the invention, the digital fingerprint further comprises network slice information.

According to an embodiment of the second aspect of the invention, the digital fingerprint further comprises quality of service information.

According to an embodiment of the second aspect of the invention, the digital fingerprint further comprises node energy measurements information.

According to an embodiment of the second aspect of the invention, the node is further configured to perform the comparison between the digital fingerprint of the first network and the digital fingerprint of the second network by calculating a similarity measure between the digital fingerprint of the first network and the digital fingerprint of the second network.

According to an embodiment of the second aspect of the invention, the node is further configured to perform the transfer of the digital twin using transfer learning to adapt the first digital twin to the second network.

According to an embodiment of the second aspect of the invention, the transfer learning algorithm comprises using domain adaptation to adapt the first digital twin to the second network.

According to an embodiment of the second aspect of the invention, the transfer learning algorithm comprises using deep neural network transfer learning to adapt the first digital twin to the second network.

According to an embodiment of the second aspect of the invention, the network node is a networks and data analytics function node.

According to a third aspect of the invention, there is a computer program comprising instructions, which, when run on a processor cause the processor to perform the method of the first, second, or third aspect of the invention.

According to a fourth aspect of the invention, there is a computer program product comprising a computer readable storage medium on which a computer program according to the fifth aspect of the invention is stored.

### BRIEF DESCRIPTION OF THE DRAWINGS

The inventive concept will now be described more fully with non-limiting reference to the accompanying drawings in which certain embodiments of the inventive concept are shown.

FIG. 1a is a flowchart of an embodiment of the method according to the invention.

FIG. 1b is a flowchart of an embodiment of the method according to the invention.

FIG. 2 is an exemplary communication system according to an embodiment of the invention.

FIG. 3 is an exemplary communication system according to an embodiment of the invention.

FIG. 4 is an exemplary network node according to the invention.

FIG. 5 is a line graph of the performance of a simulation of the method according to the invention.

### DETAILED DESCRIPTION OF THE DRAWINGS

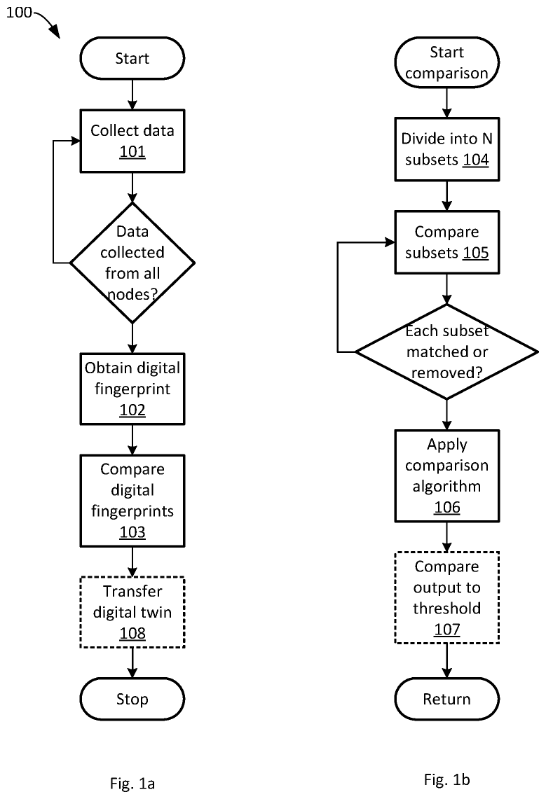

FIG. 1a is a flowchart depicting the operations of the method 100 to determine whether a digital twin of a first network is compatible with a second network.

For the purpose of this disclosure, the word “compatible” in the following refers to a digital twin of the first network, which, when transferred to the second network, enables the operator of the second network to perform a task related to the second network in a manner which is measurably more efficient, in terms of—for example—time, than performing the task without the transfer of the digital twin of the first network. Embodiments of the present disclosure include using a digital twin of the first network to configure setup parameters such as number of routers and location of the routers, model of the routers, and quality of service policies, of the second network.

The first network and the second network are typically not identical and therefore, if a digital twin of the first network and a digital twin of the second network were calculated, the digitals twins would also not be identical. Hence, the present invention provides a method enabling the determination of a similarity score of representations of the first network and the second network, which may be used by the operator to determine whether a transfer of digital twins from the first network to the second network may be useful to the operator or the customer. The “compatibility” of the digital twin of the first network with the second network may be therefore determined using a similarity score.

A network is a group of nodes interconnected by telecommunications links that are used to exchange messages between the nodes. The telecommunications links may be wired or wireless or a combination of wired and wireless links. In the present disclosure, the network is, in some embodiments, a network according to a suitable standard as defined by the 3^{rd} Generation Partnership Project, 3GPP, such as Global System for Mobile Communications, GSM, Universal Mobile Telecommunications System, UMTS, Long-Term Evolution, LTE, or 5G New Radio, 5G NR. The network may alternatively be a Wi-Fi network as defined by the Institute of Electrical and Electronics Engineers, IEEE, or any other suitable standardizing body. Alternatively, the network may be a heterogeneous network, comprising for example a combination of 5G cells and Wi-Fi 5 routers. Alternatively, or in addition, the network may comprise wired routers and/or wired devices transmitting data over, for example, an ethernet connection.

Wired or wireless devices such as for example mobile phones, desktop computers, tablets, laptops, smart devices such as smart watches, specialized industrial equipment such as robots, or security equipment such as surveillance cameras may connect to the network.

The method is particularly suitable for private networks. Private networks have become more popular with the adoption of the 5G standard since the 5G standard enables operators to personalize the network for a particular customer to a large degree. A private network is a network set up to serve the needs of a single customer, for example a factory, a warehouse, a hospital, a sports club, or a power plant. The spectrum used in private 5G networks may be unlicensed, or it may be licensed and lie outside the spectrum allotted to wireless service providers. Digital twins are ideal for private networks since they tend to comprise few node types and comparatively fewer nodes than public networks. Moreover, the behavior of devices connected to the private network is, to some extent, predictable.

A digital twin is a virtual representation of a physical entity. Once created, the digital twin can be used to represent the physical entity in a digital representation of a real world system. The digital twin is created such that it is identical in form and behavior to the corresponding physical entity. Additionally, the digital twin may mirror the status of the physical system within a greater system. For example, sensors may be placed on the physical entity to capture real-time (or near real-time) data from the physical entity to relay it back to the digital twin. The digital twin can then make any changes necessary to maintain its correspondence to the physical entity (physical twin).

The digital twin simulates the behavior of the physical entity. As such, the digital twin may be used to simulate various scenarios for the purpose of identifying fault, testing new software, or to generate training data for training machine learning algorithms for the physical entity.

A digital twin of a network comprises a logical architecture wherein one or more data pipelines comprising network data are fed into one or more environmental models which may or may not be different from each other. The output of the environmental model or models may be combined with further data and fed through an environmental model, possibly distinct from all the previous environmental models. The successive environmental models may be referred to as layers of the digital twin. The environmental model or models may be parametrized with metadata acquired or learned from the network. This may be repeated any number of times. The final output stream is the digital twin of the network. The digital twin of the network may be considered as a close simulation of the actual network. Depending on the complexity of the layers of environmental models comprising the digital twin and the interaction between the layers, the digital twin may be considered to be a neural network.

For a provider of private networks, a digital twin of a network may serve additional purposes. Setting up and optimizing a network is labor-intense and time consuming and the provider may be asked to provide multiple private networks in similar locations and with similar performance requirements. In this scenario, the provider may wish to leverage some, or all, of the knowledge gained from configuring a first network to speed up configuring a second network. In this scenario, developing a method to determine a suitable first network and transferring the digital twin of the first network to the second network is of great interest.

In an embodiment, a digital twin of a network is considered, wherein the network's operator, Operator A, wants to transfer this digital twin to another network of Operator B. In order to create a digital twin which is as close as possible to an exact replica of the network, operator A needs to collect some data of the network.

The first step 101 of the method 100 comprises collecting network data a digital fingerprint of the first network is based on. The nature of the collected network data may, in embodiments, vary depending on the nature of the first network.

The first network comprises N routers, and the network data are collected for each of the N routers. N indicates an integer number. Therefore, “N routers” means a first number of routers. As mentioned above, the first network can be any network: in the following, embodiments of specific first networks are given.

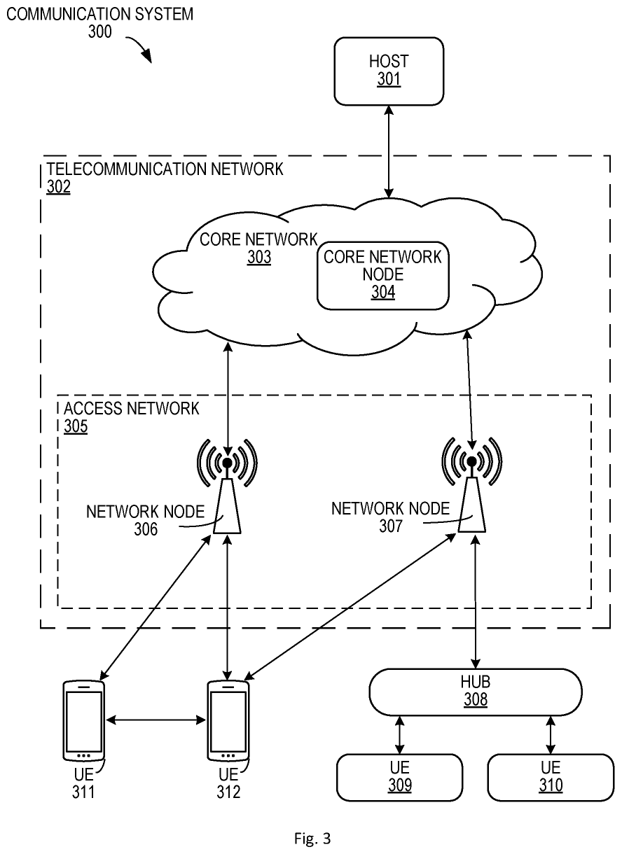

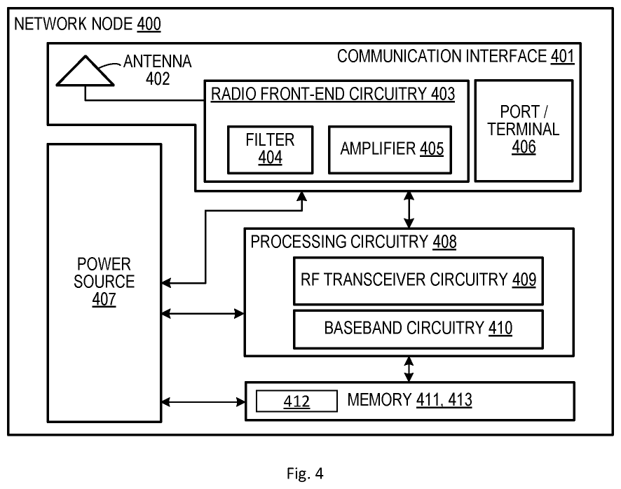

The first network may include a cellular network 302, as shown in FIG. 3. The cellular network 302 comprises a core network 303 comprising at least one core network node 304 which interfaces between the radio access network nodes 306, 307 which divide the covered are into distinct cells which each radio access node provides coverage for and the host 301 providing service. Therefore, in a cellular network, the router comprises a radio access node. The cellular network further comprises a radio access network 305 comprising radio access nodes 306, 307 which either connect directly to devices 311, 312 served by the network or to a hub 308 which provides service to devices 309, 310. Some, or all, of the devices may, in embodiments, be wired and some of the devices may be wireless.

The devices 311, 312 may attach directly to a radio access node through a wireless connection or indirectly through a wired connection to a hub 308 which in turn attaches wirelessly to a radio access node.

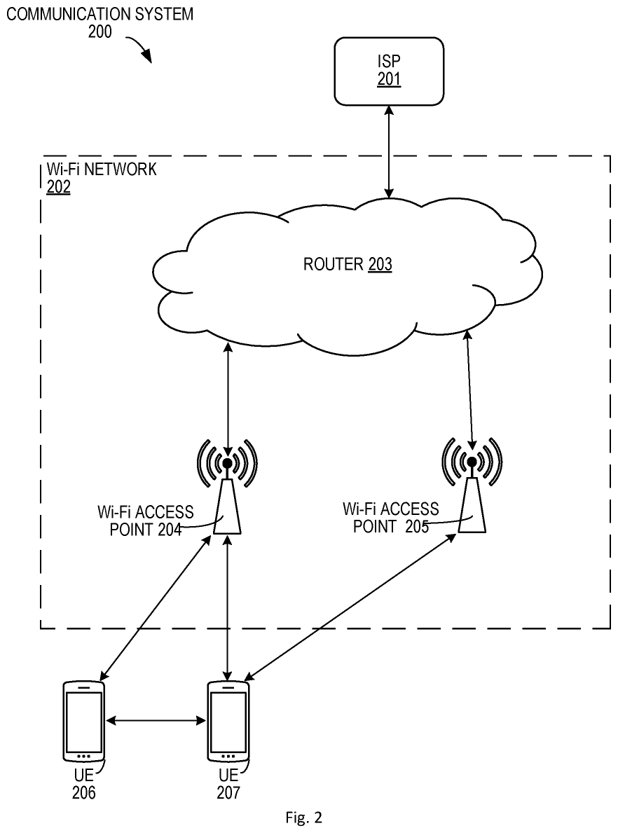

The first network may include a local area network 202, as depicted in FIG. 2, which is a network which connects a device 206, 207 to an internet service provider 201. It typically comprises at least one access point 204, 205 such as a Wi-Fi access point. It further comprises a router 203, sometimes integrated with the access point to form a Wi-Fi router. The access point connects to the device and forwards data to the router which, typically over an ethernet connection, communicates with the internet service provider.

Any given location in the area covered by a Wi-Fi network may be covered by several Wi-Fi access points. Therefore, in a Wi-Fi network, the router comprises the Wi-Fi access point. In typical use, the device connected to the Wi-Fi network will automatically choose to connect, or be manually configured to connect, to the access point which provides the fastest connection. Therefore, a Wi-Fi network is not divided into cells like a cellular network. Some, or all, of the devices served by the Wi-Fi network may, in embodiments, be wired and attach to the Wi-Fi access point using for example an ethernet cable and some devices may attach wirelessly.

In embodiments, collecting 101 the network data comprises at least collecting, for each router of the N routers in the first network, a location of the router, mobility data of devices attached to the router, and data traffic information of devices attached to the router.

The network data is collected at a specific time t and the fingerprint is a representation of the network at that time t. Some data, such as location data for each router, may be collected for that specific time t. Other data, such as mobility data of devices attached to the router and data traffic information of devices attached to the router may be collected over a time interval specified by the skilled person depending on the nature of the network. In embodiments, the time interval may be anywhere between an hour and several days. Longer time intervals may be needed to capture the behavior of a network with less regular traffic or fewer attached devices.

The method further comprises obtaining 102 a digital fingerprint based on the data from the first network. For example, a further step of the method of the invention comprises obtaining 102 a digital fingerprint of the first network on the basis of the router location, mobility data and data traffic information for all N routers. In the following, “the router location, mobility data and data traffic information for all N routers” are called collected data. The obtaining step 102 may include calculating the digital fingerprint of the first network, for example computing the digital fingerprint of the first network. The obtaining step 102 may include estimating the digital fingerprint of the first network.

In embodiments of the present disclosure, the digital fingerprint comprises the output of a lossless compression algorithm applied to data collected from the network. In particular, the digital fingerprint comprises characterizing information of the network, e.g., the network data, which has been compressed for more efficient storage and comparison to other digital fingerprints. Therefore, a digital fingerprint of a network is a compressed data structure comprising network data which characterizes the network so that a decision on whether to transfer the digital twin to a second network may be taken.

In embodiments, obtaining 102 the digital fingerprint comprises processing the collected data from network nodes and compressing the collected network data. In embodiments, obtaining 102 the digital fingerprint of the first network comprises performing a calculation on the collected network data for all N routers. The calculation may be performed by one of the nodes of the first network. The node performing the calculation, whether physical or virtual, may be referred to as the digital fingerprint calculator.

The calculation comprises, in embodiments, applying a lossless compression algorithm to the collected data. Since the collected network data, in embodiments, exhibits statistical redundancy, lossless compression algorithms are very suited for compressing the collected data into a digital fingerprint. Any suitable lossless compression algorithm may be used, such as Lempel-Ziv-Welch or Huffman coding. Applying a lossless compression algorithm to the data may be referred to as encoding the data.

In embodiments where the first network is the telecommunication network 302 of FIG. 3, for example a 5G network, the location of the radio access nodes 306, 307 is reported to the digital fingerprint calculator by the operations and support system, OSS, node. The location of each radio access node is a four-tuple comprising a cell identifier, a latitude, a longitude, and a timestamp.

The cell identifier may be a unique number associated with each radio access node 306, 307 which allows the OSS to uniquely identify the radio access node.

In some embodiments, the radio access nodes are stationary and hence the latitude and longitude of the radio access node are fixed. The latitude and longitude may be associated directly with the cell identifier in a reference table available to the digital fingerprint calculator or determined at the time the data is collected by means of some positioning service such as for example Global Positioning Service, GPS, or Global Navigation Satellite Systems, GNSS. In other embodiments, such as integrated access and backhaul, the radio access nodes 306, 307 may be mobile and the positions of the radio access nodes determined by means of a positioning service at the time the cell location is requested by the OSS. The timestamp may have any suitable granularity. It may comprise a date and a time measured to the hour, minute, second, millisecond, or any other suitable level of precision. The location of the radio access nodes may be collected once for each node, or, especially if the nodes are not stationary, collected multiple times over a time interval.

In embodiments where the first network is the local area network as the Wi-Fi network 202 of FIG. 2, the router is a Wi-Fi access point 204, 205, and the location of the Wi-Fi access point is either reported to the digital fingerprint calculator by the access point directly or, in the case of stationary access points, available in a look-up register accessible to the digital fingerprint calculator. In the case of mobile Wi-Fi access points, the location data of the Wi-Fi access point, comprises a Wi-Fi access point identifier, a latitude, a longitude, and a timestamp. The location data may be determined by either the access point itself and reported to the calculator, or tracked by another node which reports the location of the access point to the digital fingerprint calculator. The location of the Wi-Fi access points may be collected once for each access point, or, especially if the access points are not stationary, collected multiple times over a time interval.

In embodiments where the first network is the telecommunication network 302 of FIG. 3, for example a 5G network, mobility data of wireless devices attached to the radio access node is reported by the access and mobility management function, AMF, node. Alternatively, mobility data of wireless devices attached to the radio access node may be determined by the location management function, LMF, node, using data received from the AMF node. The mobility data of wireless devices attached to the radio access node comprises a four-tuple corresponding to each device served by the radio access node during the time interval data is collected, each four-tuple comprising an identifier of the radio access node currently serving the device, an identifier of the target radio access node the device is being handed over to, a timestamp, and a device identifier. Mobility data of wireless devices attached to the router is collected for each transmission served by the router in the time interval data is collected, and collected from each router.

The device identifier may take any suitable form, depending on for example the privacy and security requirements of the private network. It may, for example, comprise an international mobile subscriber identifier, IMSI, a medium access control, MAC, address of the radio transceiver of the device, or a generated identifier such as a C-IMSI.

In embodiments where the first network is a heterogeneous network where some routers are Wi-Fi access points, mobility data is reported to the calculator by each access point, either directly or collected through the router which serves the access point. Since Wi-Fi access points do not perform handovers in the manner of cellular networks, the collected mobility data will not include information about the target access node. Instead, the mobility data comprises three-tuples comprising an identifier of the Wi-Fi access point currently serving the device, a timestamp, and a device identifier.

In embodiments where the network is the telecommunication network 302 of FIG. 3, for example a 5G network, data traffic information of devices attached to the cell is reported to the digital fingerprint calculator by the user plane function, UPF, node. The data traffic information of devices attached to the radio access node is a six-tuple for each transmission provided by the radio access node comprising a device identifier, a quality of service, QoS, flow identifier, QFI, a measurement of average throughput, a direction of the traffic, a timestamp indicating the start of the transmission, and a timestamp indicating the end of the transmission. Data traffic information of wireless devices attached to the router is collected for each transmission served by the router in the time interval data is collected, and collected from each router.

The QFI may be a 5G QFI, 5QI, mechanism, classifying each packet of a transmission into a pre-set QoS class. The QoS classes may be tailored to the specific customer's needs. The average throughput measurement measures the average throughput amount of data over a pre-determined period of time, as specified by the QFI. The direction of the traffic is an indicator specifying whether the transmission is an uplink transmission or a downlink transmission.

In embodiments where some routers are Wi-Fi access points, data traffic information does not include QFI for those routers. In these embodiments, the data traffic information of devices attached to the Wi-Fi access point is reported to the digital fingerprint calculator by the Wi-Fi access point or the router serving the Wi-Fi access point and the data traffic information is restricted to the device identifier, a measurement of throughput, a direction of the traffic, a timestamp indicating the start of the transmission, and a timestamp indicating the end of the transmission. The entry corresponding to the QFI may be left blank, or set to a suitable null value such as 0 as determined by the skilled person writing their own implementation of a program that causes a digital fingerprint calculator to calculate the digital fingerprint of the first network.

When the data has been collected, or while the data is being collected, the digital fingerprint of the first network is obtained 102, for example using the digital fingerprint calculator. The digital fingerprint calculator may compress the collected data into a more manageable size which may, in different embodiments, either be directly compared to an existing digital fingerprint or stored in a database to later be used for comparisons.

After data have been collected 101 from all N routers, the digital fingerprint calculator, in embodiments, feeds the fingerprint data through a suitable lossless compression algorithm to obtain 102 the digital fingerprint of the first network. The method further comprises comparing 103 the digital fingerprint of the first network with a digital fingerprint of the second network, so that a transfer 108 of the digital twin of the first network to the second network may take place on the basis of the comparison. The digital fingerprint of the second network, having M routers, is obtained by the same steps as described above for the first network. The comparison may take place via a comparison algorithm.

M indicates an integer number. Therefore, “M routers” means a second number of routers. M and N may be the same number, that is, the first network and the second network may have the same number of routers (first number of routers (N)=second number of routers (M)), or M may be different from N, so that the first network and the second network have different numbers of routers (first number of routers (N) #second number of routers (M)).

The transfer of the digital twin of the first network to the second network means that the digital twin of the first network becomes the digital twin of the second network. This is true preferably at least at the time of the transfer. It may be possible that the digital twin of the second network, with time, will diverge from the digital twin of the first network (although identical at a given point in time, e.g., the time of the transfer), due to different data supplied to the two digital twins in the first network and in the second network.

The comparison 103 with the digital fingerprint of the second network may be performed by the same node which acts as the digital fingerprint calculator, or by a different node.

During the collecting 101 data from each router of the N routers of the first network, network data is collected from each router in turn and each collected n-tuple comprises data which may be used to associate the n-tuple to a specific router. Therefore, the collected network data can be separated into subsets each corresponding to a specific router. The collected network data comprises therefore N subsets, each subset including the network data collected for a specific router of the N routers. Each subset includes the router location, mobility data and data traffic information for a single router of the N routers. Hence, as shown in FIG. 1b, the resulting fingerprint may also be divided 104 into N subsets corresponding to collected network data from each of the N routers.

Before the comparison 103, a preprocessing step may take place. With still reference to FIG. 1b, the preprocessing may comprise comparing each subset 105 of the digital fingerprint of the first network to each subset of the digital fingerprint of the second network to obtain a first correspondence between the routers of the first network and the routers of the second network. A router of the first network may be said to correspond to a router of the second network if it shares characteristics with the router of the second network. Shared characteristics may, for example, refer to characteristics such as similar geographical location in the network, similar traffic usage, or similar configuration.

If a router in the first network has no corresponding router in the second network, for example because the two networks have a different number of routers, then the router will be flagged as non-transferrable and removed from the comparison. Similarly, any router of the second network which has not been found to correspond to any router of the first network when all routers of the first network are either found to correspond to a router of the second network or are flagged as non-transferrable will be flagged and/or removed from the comparison. In some embodiments, the non-transferrable routers are removed entirely from the fingerprint. In other embodiments, the non-transferrable routers are flagged for the comparison algorithm to ignore.

At this point, the digital fingerprint of the first network and the digital fingerprint of the second network comprise data corresponding to the same number of routers. Therefore, the digital fingerprint of the first network and the digital fingerprint of the second network can now be compared.

The comparison is in embodiments performed by applying 106 a suitable measure of similarity. For example, the comparison may, in embodiments, comprise using a similarity measure to calculate a measure of similarity between the two digital fingerprints. In embodiments where a measure of similarity is used, the comparison will result in a single number indicating the degree of similarity between the two digital fingerprints. The network operator can then use the calculated degree of similarity to determine whether to take an action in response to the comparison. The similarity measure may comprise cosine similarity. Alternatively, a kernel function such as radial basis function kernel, or hamming distance, or L¹ or L² norms may be used to obtain a measure of similarity between the digital fingerprint of the first network and the digital fingerprint of the second network.

In some embodiments, the digital fingerprint may be decoded before the comparison 103 takes place.

In embodiments of the present invention, the operator of the second network may have determined a threshold value 107 which indicates whether a transfer of the first digital twin to the second network should take place. The threshold value may depend on the comparison algorithm chosen by the operator.

in embodiments, if the similarity measure is above the threshold, the method may further comprise transferring 108 the first digital twin to the second network. Alternatively, in embodiments, if the similarity measure is below the threshold, the method may further comprise not transferring the first digital twin to the second network.

In other embodiments, the operator may make a decision to transfer the first digital twin to the second network on a case-by-case basis.

```
TABLE 1
Initialize fingerprint_data to empty string
For every current_cell_ID in cell_population
  // This part of the algorithm exports actual usage for every cell
  Initialize temp_UE_attach to empty
  For every record [rec] in device mobility data where rec.target_cell_ID == current_cell_ID [trg_cell]
    Store rec.device_UD as UE_identity
    Find record [c_rec] where c_rec.serving_cell_ID == current_cell_ID AND c_rec.device_ID ==
      UE_identity. [srv_cell]
        If exists srv_cell, get attach time for UE_identity t = |srv_cell.timestamp −
      trg_cell.timestamp|
        If not exists srv_cell, set attach time for UE_identity t = observation_period
        Add <UE_identity, t> to temp_UE_attach
  Initialize temp_cell_profile to empty, cell_total_bandwidth_ul, cell_total_bandwidth_dl
  For every current_attach_record in temp_UE_attach
    Extract current_attach_record.UE_identity = current_identity
    Get QoS and bandwidth utilization for all flows of current_identity from Qos_policies and create
          a profile UE_profile = list<5QI, |MFBR, GFBR|, b/w utilization, direction>
      Get SST from UDM
      Add <UE_profile, SST> to temp_cell_profile
  For every profile_current in temp_cell_profile, where direction = uplink, add to cell_total_bandwidth_ul
  For every profile_current in temp_cell_profile, where direction = downlink, add to
cell_total_bandwidth_dl
  From temp_cell_profile, create cell_SST = list<SST, cardinality> (cardinality means number of SSTs)
  From temp_cell_profile, create cell_5QI = list<5QI, cardinality>
  From temp_cell_profile, create cell_GBR = <average_MFBR, average_GFBR>
  // This part of the algorithm adds cell usage configuration and location information to fingerprint_data
  From radio base station configuration, retrieve List<hardware_type, hardware_ID, vendor_ID,
    software_revision>, <frequency_band, channel_bandwidth>
  From OSS, get cell_location
  Add <current_cell_ID, cell_total_bandwidth_ul, cell_total_bandwidth_dl, cell_SST, cell_5QI, cell_GBR,
    List<hardware_type, hardware_ID, vendor_ID, software_revision>, <frequency_band,
    channel_bandwidth>, cell_location> to fingerprint_data
```

The above pseudocode in Table 1 is an example of an algorithm implementing part of the method of the invention when the network is a private 5G network. In this implementation the collected network data is first initialized to an empty string. Network data refers to the location of the radio access node, mobility data of devices attached to the access point, and data traffic information of devices attached to the access point. For every radio access node in the network, the algorithm iterates over the mobility data of devices attached to that radio access node. The algorithm initializes an empty dummy variable and then iterates over every record in the device mobility data to collect the four-tuple of device mobility data. For each record, the device identifier is stored as the current UE identifier. Then the algorithm selects those records with serving radio access node equal to the current radio access node and UE identifier equal to the current UE identifier. The algorithm will then calculate the attach time of the device, depending on whether the device changed to a different serving cell during the transmission or not. Then, for each record, the UE identity and the attach time are added to the dummy variable. The radio access node identifier, the UE identifier, the attach time, and, if the device changed serving cell, the target radio access node identifier comprises the four-tuple of device mobility data.

After adding data about attached devices, new dummy variables are created to temporarily hold the cell profile, total uplink bandwidth for the cell, and total downlink bandwidth for the cell. The algorithm the iterates over each device that at some point was attached to the current radio access node, extracting the UE identity, extracting QoS information and bandwidth utilization, and extracting SST from the unified data management function. All these data are added to the temporary cell profile.

Once the temporary cell profile variable is completed, the algorithm adds each entry where the transmission was recorded as an uplink transmission to the variable holding total uplink bandwidth for the radio access node, and each entry where the transmission was recorded as a downlink transmission to the variable holding total downlink bandwidth for the radio access node.

The algorithm then creates three new variables holding the SST, along with a counter recording the number of times each SST occurs, the 5QI, along with a counter recording the number of times each 5QI occurs, and bit rate information comprising the average MFBR and average GFBR. These data correspond to the six-tuples of data traffic information of devices attached to the router.

Next, the algorithm retrieves information about the current base station: hardware type, hardware ID, vendor ID, software revision, frequency band, and channel bandwidth. Finally, the radio access node location is retrieved from the OSS node. These data correspond to location data for each router of the N routers of the network, along with example additional data further specifying the nature of the router.

After collecting all the data, all the dummy variables are added to a variable referred to as the fingerprint data.

The above is one particular embodiment of collecting 101 the data from each router in the network. The skilled person is aware that the method may be implemented differently depending on the precise network type and which data are included in the digital fingerprint.

In embodiments, the digital twin of the first network is transferred to the second network. In an embodiment, the operator determines that the degree of similarity is sufficiently high that the first digital twin should be transferred to the second network. The transfer of the first digital twin to the second network may, in embodiments, comprise using transfer learning to transfer the first digital twin to the second network.

Transfer learning comprises a wide range of techniques aimed at transferring learned parameters of a machine learning model from the source domain in which it was learned to a target domain, with the aim of solving a related problem in the target domain without having to train a new model. In the context of the present disclosure, the source domain refers to the first network and the target domain refers to the second network. Transfer learning techniques may, in embodiments, comprise for example domain adaptation or deep neural network, DNN, transfer learning.

In domain adaptation, a domain D of the transfer learning process is comprised of an n-dimensional feature space X and a marginal probability distribution P(x), where x∈X. The domain is derived from the first digital twin. Furthermore, there is an m-dimensional label space Y derived from the second digital twin. The objective is to learn a mathematical model h: X→Y capable of attaching a label from Y to an example input from X. In the language of the present disclosure, the feature space corresponds to the collected network data and the marginal probability distribution is the probability distribution corresponding to predicted network behavior learned by the digital twin of the first network.

Domain adaptation may be performed as a supervised learning process, an unsupervised learning process, or a semi-supervised learning process. Algorithms used may be based on several different principles: for example reweighting algorithms, iterative algorithms, attempting to construct a hierarchical Bayesian model, or techniques such as adversarial machine learning to search for a common representation space.

In other embodiments, DNN transfer learning may be used. In the simplest case, DNN transfer learning comprises copying the weights of the DNN of the source domain, that is, the digital twin of the first network, to a new DNN corresponding to the target domain, that is, to construct a digital twin of the second network. Other methods such as federated learning combine weights from different DNNs to create a global DNN using an algorithm such as federated averaging, which averages the weights of every DNN for every neuron (this could be the case for example when digital twins from multiple deployments contribute to the transfer). In simpler cases, where there is no DNN present, for example in case the model is a linear regression model, then the parameters of the model are transferred, e.g., the slope and the intercept.

Suitable algorithms to use may comprise, for example, any variation of multi-task learning as surveyed in ArXiV 1706.05098. Alternatively, variations of domain adaptation such as those surveyed in ArXiV 2010.03978 may be used.

Alternatively, federated learning, and in particular federated averaging may be used to adapt the first digital twin to the second network.

In embodiments, either the digital fingerprint of the first network or the digital fingerprint of the second network may be stored in a fingerprint database after calculation. Storing the fingerprint in a fingerprint database may be advantageous to operators, who may build up a large database over time and have a higher chance of finding a compatible digital twin to transfer.

In some embodiments, the fingerprint database may take the form of a distributed ledger, relying on blockchain technology to ensure the integrity of each digital fingerprint. This may be advantageous in embodiments where several operators, who may not fully trust each other, wish to maintain a shared fingerprint database of digital fingerprints to increase the chance of finding a compatible digital twin to facilitate a task in one of their own networks.

In some embodiments, the step of collecting 101 digital fingerprint data of the first network or second network may comprise collecting additional data. In embodiments where the first network or the second network is a cellular network, the additional data may comprise network slice information associated to each cell in the network may be collected. In embodiments where the network is the telecommunication network 302 of FIG. 3, for example a 5G network, network slice information associated to each cell is collected from the unified data management, UDM, node. The network slice information is a four-tuple corresponding to each recorded transmission comprising a device identifier of the UE making the transmission, single network slice selection assistance information slice/service type, S-NSSAI SST, S-NSSAI slice differentiator, S-NSSAI SD, and a timestamp of the transmission. Network slice information is collected for each transmission served by the router in the time interval data is collected, and then collected from each router.

The S-NSSAI information comprises information required to identify a network slice. The S-NSSAI SST comprises an identifier which identifies the expected network slice behavior in terms of features and services. Some S-NSSAI SST values are standardized, but one of the advantages of a private 5G network is that additional, customized, slice/service types may be developed to suit a particular customer. The S-NSSAI SD comprises optional information which differentiates amongst multiple network slices of the same SST type.

In embodiments where the first or the second network is a cellular network, the step of collecting 101 digital fingerprint data may further comprise collecting quality of service, QoS, information. In embodiments where the cellular network is the telecommunication network 302 of FIG. 3, for example a 5G network, the QoS information associated to each cell is collected from the policy control function, PCF, node. The QoS information associated with each transmission registered with the cell is a four-tuple comprising a device identifier, policy charging and control rules, PCC, which comprises a QoS flow identifier, a 5G QoS indicator, 5QI, a maximum flow bit rate, MFBR, a guaranteed flow bit rate, GFBR, and a direction of the transmission, and a timestamp of the transmission. QoS information is collected for each transmission served by the router in the time interval data is collected, and then collected from each router.

PCC rules enable operators to dynamically control network resources through different policies for different transmissions. The QoS flow identifier and 5QI indicate which, possibly customized, policy was used for a given transmission. MFBR and GFBR record the associated maximum flow bit rate and guaranteed flow bit rate.

In embodiments where the first or the second network is a cellular network, the step collecting 101 digital fingerprint data may further comprise collecting energy measurements information associated to each cell. The energy measurements information associated to each cell is a seven-tuple comprising a cell identifier, a measurement of power utilization, a battery capacity, a battery state of charge, a battery depth of discharge, a frequency measure associated with the battery, and a timestamp of the energy measurements information. Energy measurements information is collected for each router, either as a single measurement or recorded over a period of time.

The power utilization may be a ratio or percentage of the total battery capacity. The battery capacity may be given in for example Ampère hours or any other suitable unit. The battery state of charge is a ratio of the available capacity and the maximum possible charge which may be stored in the battery. The depth of discharge is a measure of how much energy is cycled into and out of the battery on a given cycle. Depth of discharge is expressed as a ratio or percentage of the total capacity of the battery.

In some embodiments of the invention, the digital fingerprint of the first network or the digital fingerprint of the second network are calculated repeatedly. This means that the network data are collected and turned into a digital fingerprint at either regular intervals or manually triggered by an administrator of the first network or the second network. If the network data are collected at regular intervals, the duration of the intervals may be set by the operator or the customer. Suitable intervals may be anywhere in the range of days to months. Updating the digital fingerprint at short time intervals may be more important in the case of a dynamic network were utilization changes regularly. If the updated versions of the fingerprint are triggered manually, then the administrator may for example choose to do so in conjunction with updating hardware or software components of the network, or after larger changes sch as connecting a new device or new set of devices to the network.

The method of the invention may, in embodiments, be performed in by a network node 400. The network node may comprise a memory 411 and processing circuitry 408 further comprising radio frequency transceiver circuitry 409 and baseband circuitry 410 adapted to performing the method according to any embodiment of the invention. The network node may further comprise a communication interface 401, further comprising an antenna 402, radio front-end circuitry 403 comprising a filter 404 and an amplifier 405, and a port/terminal 406. Finally, the node may comprise a power source 407. In embodiments where the first network is the telecommunication network 302 of FIG. 3, for example a 5G network, the network node performing the method may be a network data analytics function, NWDAF, node. In other embodiments, the data collection, processing, and calculating the digital fingerprint may be split between a plurality of network nodes.

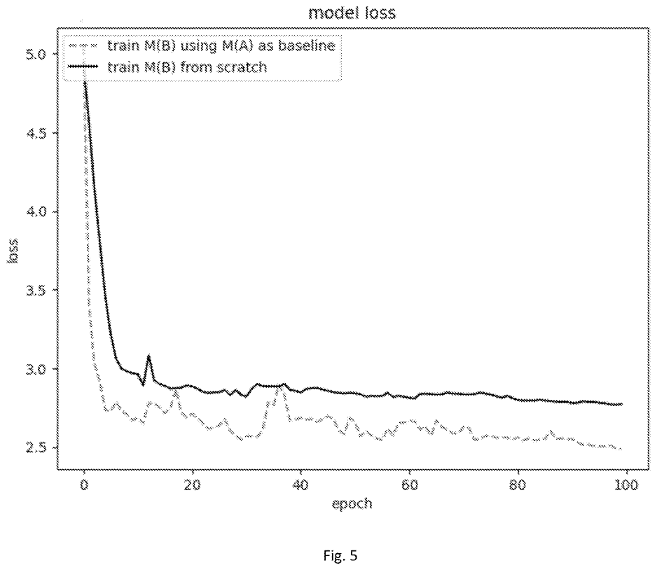

FIG. 5 depicts the output of a simulation of the method according to the invention. The simulation uses data from two networks, A and B, managed by Swisscom Operator over one month. The simulation comprises calculating a fingerprint F(A) of network A and a fingerprint F(B) of network B according to the method of the invention. A vector similarity measure applied to the two fingerprints returns a similarity of 0.91. A digital twin M(A) of network A was trained using a long short-term memory, LSTM, network. The graph depicts the training loss when training M(B) independently of M(A) compared to the training loss when transferring M(A) as a baseline for M(B) as in the method of the invention. The graph clearly shows consistently lower training loss for using the transferred digital twin compared to building a digital twin ab initio.

1. A method to transfer a digital twin of a first network to a second network, wherein the first network comprises N routers and the second network comprises M routers, the method comprising:
obtaining for each router of the N routers of the first network:
a location of the router;
mobility data of wireless devices attached to the router; and
data traffic information of devices attached to the router;
computing a digital fingerprint of the first network on the basis of the router location, mobility data and data traffic information for all N routers; and
comparing the digital fingerprint of the first network with a digital fingerprint of the second network, so that a transfer of the digital twin of the first network to the second network may take place on the basis of the comparison.

2. The method according to claim 1, comprising transferring the digital twin of the first network to the second network.

3. The method according to claim 2, wherein transferring the digital twin of the first network to the second network comprises using transfer learning to transfer the first digital twin to the second network.

4. The method according to claim 3, wherein transferring the digital twin of the first network to the second network comprises using domain adaptation to transfer the first digital twin to the second network.

5. The method according to claim 3, wherein transferring the digital twin of the first network to the second network comprises using deep neural network transfer learning to transfer the first digital twin to the second network.

6. The method according to claim 1, wherein obtaining the digital fingerprint of the first network comprises applying a lossless compression algorithm to the router location data, the mobility data, and the data traffic information obtained from each router of the N routers.

7. The method according to claim 6, further comprising creating a digital fingerprint of the second network and comparing each element of the digital fingerprint of the first network with each element of the digital fingerprint of the second network.

8. The method according to claim 1, wherein comparing the digital fingerprint of the first network with the digital fingerprint of the second network comprises calculating a similarity measure as a function of the digital fingerprint of the first network and the digital fingerprint of the second network.

9. The method according to claim 1, wherein:
comparing the digital fingerprint of the first network with the digital fingerprint of the second network includes determining a similarity between the digital fingerprint of the first network and the digital fingerprint of the second network; and
wherein the method further includes comparing the similarity with a threshold and, if the similarity is above the threshold, transferring the digital twin of the first network to the second network.

10. The method according to claim 1, wherein:
comparing the digital fingerprint of the first network with the digital fingerprint of the second network includes determining a similarity between the digital fingerprint of the first network and the digital fingerprint of the second network; and
wherein the method further includes comparing the similarity with a threshold and, if the similarity is below the threshold, not transferring the digital twin of the first network to the second network.

11. The method according to claim 1, further comprising storing the digital fingerprint of the first network or the digital fingerprint of the second network in a database.

12. (canceled)

13. The method according to claim 1, wherein the first network is a cellular network and wherein the method comprises:
obtaining for each radio access node of the N radio access nodes of the first network, at least one of:
network slice information associated to each radio access node of the N radio access nodes;
quality of service information associated to each radio access node of the N radio access nodes; and node energy measurements information associated to each radio access node of the N radio access nodes; and
obtaining the digital fingerprint of the first network on the basis of the obtained information of all N radio access nodes.

14.-15. (canceled)

16. A network node in a first network comprising N routers, the network node comprising a memory and processing circuitry adapted to obtaining, for each of the N routers in the first network:
a location of the router;
mobility data of wireless devices attached to the router;
data traffic information of devices attached to the router;
computing a digital fingerprint of the first network on the basis of the router location, mobility data, and traffic information for all N routers; and
comparing the digital fingerprint of the first network with a digital fingerprint of a second network, so that transfer of a digital twin of the first network to the second network may take place on the basis of the comparison.

17.-31. (canceled)

32. A computer program product which comprises a computer readable storage medium on which a computer program comprising program code to be executed by a processor of a network node operating in a telecommunications network, whereby execution of the program code causes the network node to:
obtain for each router of N routers of a first network:
a location of the router;
mobility data of wireless devices attached to the router; and
data traffic information of devices attached to the router;
compute a digital fingerprint of the first network on the basis of the router location, mobility data and data traffic information for all N routers; and
compare the digital fingerprint of the first network with a digital fingerprint of the second network, so that a transfer of the digital twin of the first network to the second network may take place on the basis of the comparison.
